(19) United States
(12) Patent Application Publication
(10) Pub. No.: US 2008/0148860 A1
(43) Pub. Date: Jun. 26, 2008

(54) Pressure sensor with sensing element disposed on stem

(75) Inventors: Yoshifumi Murakami, Oobu-shi (JP); Kiyoshi Otsuka, Kariya-shi (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/987,299

(22) Filed: Nov. 29, 2007

(30) Foreign Application Priority Data
Dec. 20, 2006 (JP) 2006-342466

(51) Int. Cl. G01L 9/04

(52) U.S. Cl. 73/726

(57) ABSTRACT

A pressure sensor has a polygonal cylindrical stem having a bottom wall and a plurality of side walls including a remarked side wall, a diaphragm constituted by a portion of the remarked side wall, and a sensing element attached to the remarked side wall. Each of the side walls extends along a longitudinal direction of the stem so as to face a hollow of the stem. A center axis of the hollow along the longitudinal direction is shifted from a center axis of the stem toward the remarked side wall so as to differentiate a thickness of the remarked side wall from those of the other side walls. The diaphragm is deformable in response to a pressure of a medium introduced in the hollow. The sensing element senses a deformation of the diaphragm and outputs a sensing signal indicating the deformation of the diaphragm.

### CROSS-REFERENCE TO RELATED APPLICATION

This application is based upon and claims the benefit of priority of the prior Japanese Patent Application 2006-342466 filed on Dec. 20, 2006 so that the contents of which are incorporated herein by reference.

### BACKGROUND OF THE INVENTION

1. Field of the Invention

The present invention relates to a pressure sensor wherein a sensing element is attached to a diaphragm formed in a cylindrical stem with a bottom to detect a pressure of a gas or liquid medium introduced into a hollow of the stem.

2. Description of Related Art

A pressure sensor with a sensing element has been proposed, for example, in Published Japanese Patent Second Publication No. H07-011461 and Published Japanese Patent First Publication No. 2005-147795. This pressure sensor has a cylindrical stem with a bottom wall and a plurality of side walls facing a hollow. After the formation of the hollow in the stem, the bottom wall of the stem is thinned, so that the bottom wall acts as a diaphragm. A sensing element is attached to the bottom wall acting as a diaphragm, and a board of a processing circuit is attached to the bottom wall or one side wall of the stem.

When a gas or liquid medium is introduced from an opening of the stem into the hollow of the stem, the diaphragm is deformed in response to a pressure of the medium, and the sensing element attached to the diaphragm produces a sensing signal in response to the deformation of the diaphragm. The processing circuit processes the sensing signal to detect the pressure of the medium.

In this pressure sensor, a measurable (or designed) pressure range depends on a material of the stem and a thickness of the diaphragm of the stem. Therefore, to produce a pressure sensor detecting a pressure of a medium within a desired pressure range, a material and a size of a stem and a size of a hollow are determined in a design study according to the desired pressure range. Then, a hollow is formed into the stem such that a center axis of the hollow accords with a center axis of the stem, and a bottom wall of the stem is precisely thinned to detect a pressure of a medium with an appropriate precision.

However, in the mass production of a plurality of pressure sensors, a pressure range required for each pressure sensor differs from those required for the other pressure sensors. Therefore, it is troublesome to design a material and a size of a stem and a size of a hollow for each stem. Further, to detect a pressure of a medium with a high precision, a diaphragm constituted by the bottom wall of the stem is required to be precisely thinned to a predetermined value. Therefore, in the mass production, it is difficult to standardize a material and a size of the stem and a size of the hollow of the stem. Further, it is difficult to standardize parts attached to the stem. In this case, it is difficult to maintain the manufacturing quality of the stem at a low manufacturing cost for each pressure sensor. As a result, the manufacturing cost of the pressure sensor is increased.

### SUMMARY OF THE INVENTION

An object of the present invention is to provide, with due consideration to the drawbacks of the conventional pressure sensor, a pressure sensor which reliably detects a pressure of a medium within a desired pressure range with an appropriate precision at a low manufacturing cost, regardless of whether the pressure range is changed in a design study.

According to a first aspect of this invention, the object is achieved by the provision of a pressure sensor comprising a cylindrical stem having a remarked side wall and a hollow, a diaphragm constituted by a portion of the remarked side wall or the whole remarked side wall, and a sensing element, disposed on the remarked side wall. The remarked side wall of the stem extends along a longitudinal direction of the stem so as to face the hollow of the stem. A center axis of the hollow along the longitudinal direction is differentiated from a center axis of the stem along the longitudinal direction. The diaphragm is deformable in response to a pressure of a medium introduced in the hollow of the stem. The sensing element senses a deformation of the diaphragm and outputs a sensing signal indicating the deformation of the diaphragm.

With this structure of the pressure sensor, a thickness of the diaphragm is determined from a size of the stem, a size of the hollow, and a difference between the center axes of the stem and the hollow. A measurable pressure range of the pressure sensor is determined from the thickness and material of the diaphragm. In the mass production of a plurality of pressure sensors, a size and a material of each of stems and a size of the hollow of the stem are fixed to standardize the stems not yet forming hollows. Therefore, even when a measurable pressure range of each pressure sensor differs from those of the other pressure sensors, a measurable pressure range of the pressure sensor can be easily set at a desired range by adjusting a difference between the center axes of the stem and the hollow. In this case, stems not yet forming hollows can be easily standardized, so that the pressure sensor can be manufactured at a low cost.

Further, because the diaphragm is constituted by the remarked side wall, precision in the pressure detection of the pressure sensor is determined only by a precision in the difference between the center axes of the stem and the hollow. Therefore, the pressure sensor can be manufactured at a low cost so as to reliably detect a pressure of the medium with an appropriate precision.

Accordingly, regardless of whether a measurable pressure range of the pressure sensor is changed in a design study, the pressure sensor can reliably detect a pressure of the medium within a desired pressure range with an appropriate precision at a low manufacturing cost.

According to a second aspect of this invention, the object is achieved by the provision of a pressure sensor comprising a cylindrical stem having a plurality of side portions including a remarked side portion, a diaphragm constituted by the remarked side portion, and a sensing element disposed on the remarked side portion of the stem. Each of the side portions of the stem extends along a longitudinal direction of the stem so as to face a hollow of the stem. A thickness of the remarked side portion along a direction perpendicular to the longitudinal direction is differentiated from a thickness of each of the other side portions. The diaphragm is deformable in response to a pressure of a medium introduced in the hollow of the stem. The sensing element senses a deformation of the diaphragm and outputs a sensing signal indicating the deformation of the diaphragm.

With this structure of the pressure sensor, when a size and a material of the stem and a size of the hollow are fixed to standardize stems not yet forming hollows, a measurable pressure range of the pressure sensor is determined only from a thickness of the diaphragm. Therefore, when a thickness of the remarked side portion is set at a specific value differentiated from a thickness of each of the other side portions, a measurable pressure range of the pressure sensor can be easily set at a desired pressure range. In this case, stems not yet forming hollows can be easily standardized, so that the pressure sensor can be manufactured at a low cost.

Further, the precision in the pressure detection of the pressure sensor is determined only from a precision in the setting of the thickness of the remarked side portion. Therefore, the pressure sensor can be manufactured at a low cost so as to reliably detect a pressure of the medium with an appropriate precision.

Accordingly, regardless of whether a measurable pressure range of the pressure sensor is changed in a design study, the pressure sensor can reliably detect a pressure of the medium within a desired pressure range with an appropriate precision at a low manufacturing cost.

### BRIEF DESCRIPTION OF THE DRAWINGS

FIG. 1 is a longitudinal sectional view of a pressure sensor according to the first embodiment of the present invention;

FIG. 2 is a plan view of the pressure sensor seen substantially along an arrow A of FIG. 1;

FIG. 3 is a side view of the pressure sensor seen substantially along an arrow C of FIG. 2, with a portion of an outer pipe broken away to reveal a sensing element and bonding wires;

FIG. 4A is a transverse sectional view of a stem of the pressure sensor shown in FIG. 1;

FIG. 4B is a longitudinal sectional view of the stem taken substantially along line D-D of FIG. 4A;

FIG. 5A is a transverse sectional view of a hexagonal cylindrical stem, cut on a plane perpendicular to a longitudinal direction of the stem, according to the second embodiment of the present invention;

FIG. 5B is a longitudinal sectional view of the stem taken substantially along line E-E of FIG. 5A;

FIG. 6A is a transverse sectional view of an octagonal cylindrical stem, cut on a plane perpendicular to a longitudinal direction of the stem, according to the third embodiment of the present invention;

FIG. 6B is a longitudinal sectional view of the stem taken substantially along line F-F of FIG. 6A;

FIG. 7A is a transverse sectional view of a circular cylindrical stem, cut on a plane perpendicular to a longitudinal direction of the stem, according to the first modification of the third embodiment;

FIG. 7B is a longitudinal sectional view of the stem taken substantially along line G-G of FIG. 7A;

FIG. 8 is a sectional view of an elliptic cylindrical stem, cut on a plane perpendicular to a longitudinal direction of the stem, according to the second modification of the third embodiment;

FIG. 9A is a transverse sectional view of a hexagonal cylindrical stem with a hexagonal columnar hollow, cut on a plane perpendicular to a longitudinal direction of the stem, according to the fourth embodiment of the present invention;

FIG. 9B is a longitudinal sectional view of the stem taken substantially along line H-H of FIG. 9A;

FIG. 10A is a front view of a stem with a processing circuit unit according to the fifth embodiment of the present invention;

FIG. 10B is a plan view of the stem seen along a direction indicated by an arrow I of FIG. 10A;

FIG. 11A is a front view of a stem with a screw according to the sixth embodiment of the present invention; and

FIG. 11B is a plan view of the stem seen along a direction indicated by an arrow J of FIG. 11A.

### DETAILED DESCRIPTION OF THE PREFERRED EMBODIMENTS

Embodiments of the present invention will now be described with reference to the accompanying drawings, in which like reference numerals indicate like parts, members or elements throughout the specification unless otherwise indicated.

A pressure sensor according to each of embodiments is, for example, used for detection of a pressure of brake oil used in a brake system of a vehicle or detection of a pressure of fuel disposed in a fuel pipe of a fuel injection system of a vehicle.

### First Embodiment

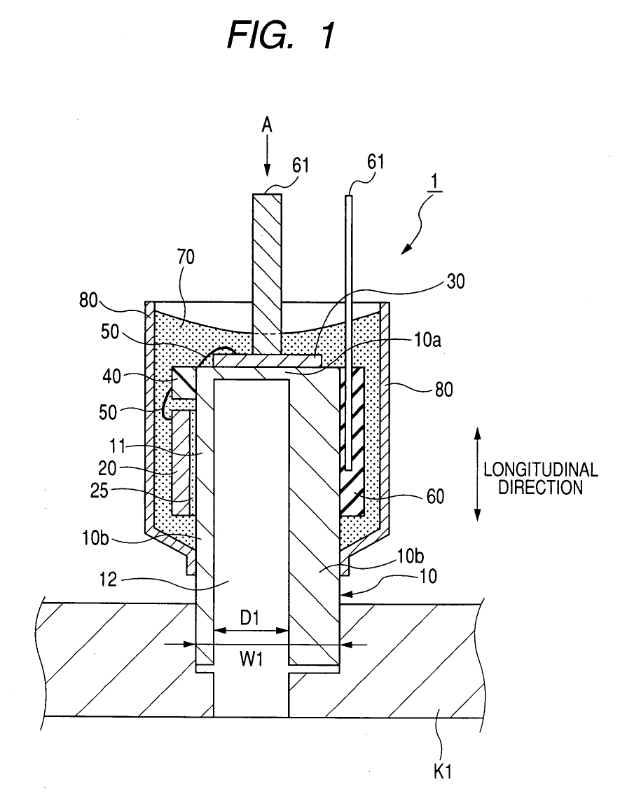

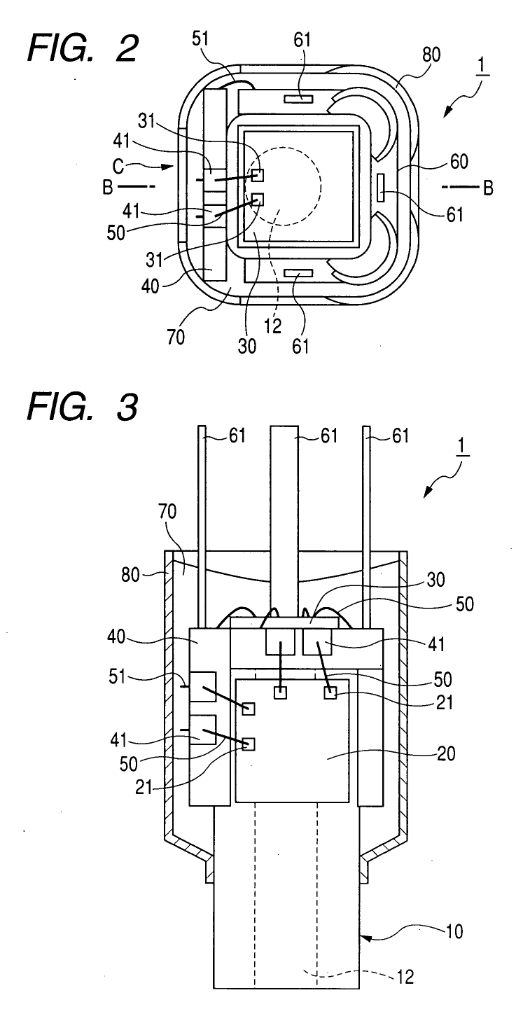

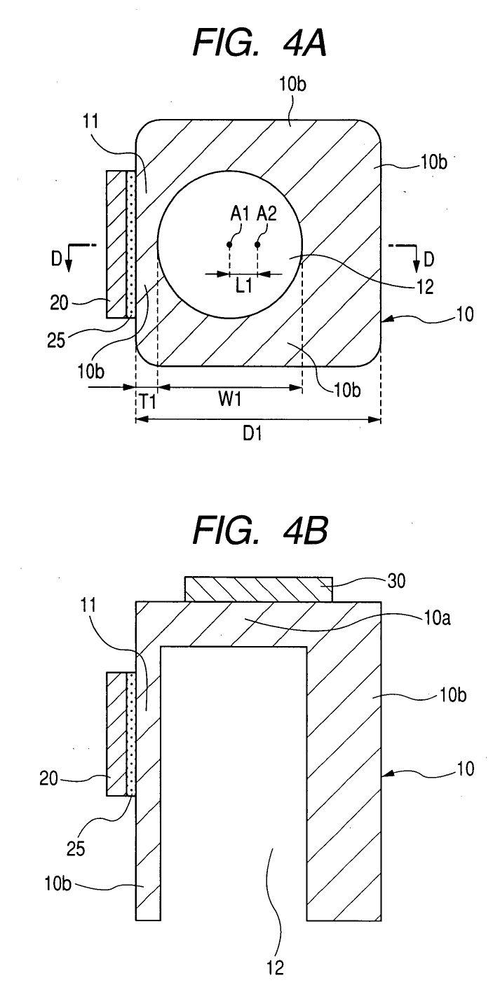

FIG. 1 is a longitudinal sectional view of a pressure sensor, receiving a measured medium held in a pipe, according to the first embodiment, while FIG. 2 is a plan view of the pressure sensor seen substantially along an arrow A of FIG. 1. A sectional view taken substantially along line B-B of FIG. 2 is also shown as FIG. 1. FIG. 3 is a side view of the pressure sensor seen substantially along an arrow C of FIG. 2, with a portion of an outer pipe 80 broken away to reveal a sensing element and bonding wires. FIG. 4A is a transverse sectional view of a stem of the pressure sensor, while FIG. 4B is a longitudinal sectional view of the stem taken substantially along line D-D of FIG. 4A.

As shown in FIG. 1, FIG. 2 and FIG. 3, a pressure sensor 1 has a square-cylindrical stem 10 with a bottom wall 10a and four side walls (or side portions) 10b facing a hollow 12, a diaphragm 11 constituted by a portion of one side wall 10b (hereinafter, called remarked side wall 10b) or the whole remarked side wall 10b of the stem 10, and a sensor chip 20 (or sensing element) fixedly attached to an outer surface of the remarked side wall 10b. The diaphragm 11 is deformable in response to a pressure of a medium introduced in the hollow 12 of the stem 10. The sensor chip 20 senses a deformation of the diaphragm 11 and outputs a sensing signal indicating the deformation of the diaphragm 11.

The stem 10 is formed out of a square-columnar metallic body not having a hollow. Four side corners of this body are rounded, and a hole is dug in a center portion of the body to form the stem 10 with the hollow 12. Each of the side walls 10b extends along a longitudinal direction of the stem 10, and inner surfaces of the walls 10a and 10b surround the hollow 12. Each of the walls 10a and 10b has a flat outer surface. The hollow 12 is closed by the bottom wall 10a at a bottom end of the stem 10. A top end of the stem 10 is opened and is tightly inserted into a pipe K1 such that a measured medium such as brake oil or fuel flowing through the pipe K1 is introduced into the hollow 12 of the stem 10. The stem 10 is fixed to the pipe K1 by a screw connection or a caulked joint to hermetically seal the medium within the hollow 12.

As shown in FIG. 4A and FIG. 4B, the hollow 12 is formed in a columnar shape and has a circular shape on a plane perpendicular to the longitudinal direction. A center axis A1 of the hollow 12 extending along the longitudinal direction is differentiated from a center axis A2 of the stem 10, so that the thickness of the remarked side wall 10b along a lateral direction perpendicular to both the longitudinal direction and the outer surface of the side wall 10b is differentiated from those of the other side walls 10b. More specifically, the center axis A1 of the hollow 12 is shifted from the center axis A2 of the stem 10 toward the remarked side wall 10b by a predetermined length L1, so that the thickness of the remarked side wall 10b disposing the sensor chip 20 is set to be smallest among those of the side walls 10b. A minimum thickness T1 of the remarked side wall 10b (i.e., diaphragm 11) is determined from a width W1 between the outer surfaces of the remarked side wall 10b and the side wall 10b opposite to each other, an inner diameter D1 of the hollow 12, and the length L1. A relation: T1=(W1−D1)/2−L1 is satisfied.

In a case where the pressure sensor 1 is used to detect an extra-high pressure, the stem 10 made of a metal is required to have a high stiffness or strength against the pressure. For example, the stem 10 is made of an alloy which mainly contains iron Fe, nickel Ni and cobalt Co or mainly contains Fe and Ni. The alloy slightly contains titanium Ti, niobium Nb and aluminum Al or slightly contains Ti and Nb. The stem 10 is formed by shaping this alloy by press working, cutting work, cold hammering, drilling and the like.

The sensor chip 20 is formed of a semiconductor chip made of a mono-crystal silicon or the like. The sensor chip 20 is fixedly attached to an outer surface of the remarked side wall 10b through a glass layer 25 having a low melting point. When the chip 20 is made of silicon, the chip 20 is required to have a low thermal expansion coefficient because of a low thermal expansion of the glass layer 25. The sensor chip 20 has a strain gauge with a bridge circuit, and a resistance in the bridge circuit is changed in response to a deformation of the diaphragm 11. The sensor chip 20 converts a change of the resistance into an electric sensing signal. A measurable pressure range in the sensor chip 20 is determined from a material of the diaphragm 11, the thickness T1 of the diaphragm 11, and a positional relation between the diaphragm 11 and the sensor chip 20.

With this structure of the pressure sensor 1, when the measured medium is introduced into the hollow 12 of the stem 10, the diaphragm 11 receives a pressure of the measured medium and is distorted or deformed according to the pressure. The sensor chip 20 disposed on the outer surface of the diaphragm 11 produces an electric sensing signal indicating a deformation of the diaphragm 11.

As shown in FIG. 1, FIG. 2 and FIG. 3, the pressure sensor 1 may further have a processing circuit board 30 fixedly attached to an outer surface of the bottom wall 10a of the stem 10. The bottom wall surface mounting the board 30 is perpendicular to the side wall surface mounting the sensor chip 20 so as to size down the bottom wall 10a on a plane perpendicular to the longitudinal direction. The board 30 is constituted by a ceramic board or a printed board on which a processing circuit such as a semiconductor integrated circuit chip or a semiconductor circuit chip is mounted. The processing circuit of the board 30 amplifies the sensing signal of the sensor chip 20 and produces a pressure signal indicating the pressure of the measured medium. In this embodiment, the outer surface of the bottom wall 10a is flattened to stably hold the board 30 thereon. However, the outer surface of the bottom wall 10a may be curved.

The pressure sensor 1 may further have a three-dimensional wiring element 40 fixedly attached to the remarked side wall 10b through an insulator such as an adhesive agent, and a pin assembly 60 fixedly attached to the other three side walls 10b through an insulator such as an adhesive agent. The wiring element 40 is disposed between the chip 20 and the board 30. The wiring element 40 has an insulation body made of resin and a plurality of pads (or electrodes) 41 disposed on the surface of the body. The sensor chip 20 has a plurality of pads (or electrodes) 21. A plurality of bonding wires 50 connect the pads 21 of the chip 20 with the pads 41 of the wiring element 40, respectively. The board 30 has a plurality of pads (or electrodes) 31. A plurality of other bonding wires 50 connect the pads 31 of the board 30 with the pads 41 of the wiring element 40, respectively. Therefore, the chip 20 is electrically connected with the processing circuit of the board 30 through the wiring element 40 and the bonding wires 50.

The pin assembly 60 has an insulation body made of resin and three pins 61 inserted into the body. The pins 61 are composed of a sensor output terminal, a grounded terminal and a power terminal. The three terminals 61 are disposed on the three side walls 10b, respectively. The terminals 61 are electrically connected with external devices such as an electronic control unit (ECU) and the like of a vehicle through wiring members. Further, the pin assembly 60 is electrically connected with the wiring element 40 through a bonding wire 51. More specifically, the pin assembly 60 has a pad (not shown) connected with the sensor output terminal 61 on a side surface of the assembly 60 facing the wiring element 40, and the bonding wire 51 electrically connects the pad of the pin assembly 60 and a pad (not shown) of the wiring element 40.

Therefore, the sensor chip 20, the board 30 and the pin assembly 60 are electrically connected with one another through the bonding wires 50 and 51. A sensing signal of the sensor chip 20 is processed in the processing circuit of the board 30 and is outputted to an external device through the pin assembly 60.

As shown in FIG. 1 and FIG. 2, the sensor chip 20, the board 30 and the pin assembly 60 may be covered with a gel member 70 made of an electrically insulating material such as Si gel. The gel member 70 protects the chip 20, the board 30 and the assembly 60 from external shocks. A square-cylindrical pipe 80 made of a metal may be attached to the stem 10 so as to surround the diaphragm 11, the sensor chip 20, the board 30 and the pin assembly 60. The gel member 70 is packed into the pipe 80. To attach the pipe 80 to the stem 10, the stem 10 is inserted into the pipe 80, and the pipe 80 is fixedly attached to the stem 10 by welding or pressing work.

Next, a manufacturing method of the pressure sensor 1 is now described below.

A stem is initially prepared from a square-columnar metallic block. The block is shaped by press working so as to have four rounded side corners, and a hole is drilled in the center portion of the block from one end of the block. In a prior art for the comparison with this embodiment. The hole is precisely drilled such that a center axis of a drill accords with a center axis of the block, and a hollow is formed in the block. Then, a bottom wall of the block is precisely thinned by cutting work to form a diaphragm constituted by the bottom wall, so that a stem with the diaphragm is formed. Therefore, in the prior art, in addition to the drilling, it is required to precisely cut the bottom wall of the block so as to adjust a thickness of the diaphragm. That is, it is troublesome to produce a stem from the metallic block with high precision. Further, it is difficult to produce stems having various pressure ranges from a plurality of metallic blocks having the same size in mass production.

In contrast, in this embodiment, a hollow 12 is formed in the block such that a center axis of the hollow 12 is shifted from a center axis of the stem 10 to set a thickness of the remarked side wall 10b (i.e., diaphragm 11) at a predetermined value corresponding to a desired pressure range of a pressure sensor. In this drilling, a drill is used to shape the hollow 12 in a circular form in section. A diameter of the hollow 12, that is, an inner diameter of the stem 10 is determined by an outer diameter of the drill. An external size W1 and a material of the stem 10 are standardized to produce the stem 10 at a low cost. A size of the drill is predetermined to efficiently drill a hollow into each of metallic blocks. Therefore, a thickness of the diaphragm 11 is determined only by a shift of the center axis of the drill from the center axis of the stem 10. In this case, a thickness of the diaphragm 11 can be appropriately set only by adjusting a position of the center axis of the drill with respect to the center axis of the stem 10. Therefore, the precision in the thickness of the diaphragm 11 is determined only by a precision in the drilling.

After the stem 10 is formed, a glass layer 25 having a low melting point is printed on an outer surface of the remarked side wall 10b (glass printing step), and the sensor chip 20 is mounted on the glass layer 25 (sensor chip assembling step). Then, the glass layer 25 is melted and solidified to fixedly attach the chip 20 to the stem 10. Further, the board 30 is fixedly attached to an outer surface of the bottom wall 10a of the stem 10 by using an adhesive agent (board assembling step). In the same manner, the wiring element 40 is fixedly attached to an outer surface of the remarked side wall 10b by using an adhesive agent, and the pin assembly 60 is fixedly attached to an outer surface of the other side walls 10b by using an adhesive agent (fixedly attaching steps).

Thereafter, bonding wires 50 formed of gold or aluminum are prepared, and the pads 21 of the chip 20, the pads 31 of the board 30 and the pads 41 of the element 40 are connected with one another through the bonding wires 50 (wire bonding step). Therefore, the chip 20, the board 30 and the element 40 are electrically connected with one another. Further, a bonding wire 51 formed of gold or aluminum is prepared, and a pad of the element 40 and a pad of the assembly 60 are connected with each other through the bonding wire 51. Therefore, the element 40 and the assembly 60 are electrically connected with each other.

Thereafter, the pipe 80 is fitted to the stem 10 (pipe assembling step). More specifically, the stem 10 is positioned such that an opening of the hollow 12 faces a wide opening of the pipe 80. Then, the stem 10 is inserted into the pipe 80 so as to reach a narrow opening of the pipe 80, and an end portion of the pipe 80 at the narrow opening is welded to the side walls 10b of the stem 10. Alternatively, the stem 10 is inserted into and pressed to the pipe 80 such that the stem 10 is fixedly attached to the pipe 80. Thereafter, the gel member 70 is packed into the pipe 80 and is solidified (gel coating and solidifying step) to form the pressure sensor 1. More specifically, the gel member 70 formed of silicon gel is poured into the pipe 80 from the wide opening of the pipe 80 so as to be packed into the pipe 80. Assuming that air bubbles exist in the gel member 70, resistance of the member 70 against low temperature is lowered. Therefore, to prevent air bubbles from being formed in the gel member 70, it is preferred that the gel member 70 be poured into the pipe 80 in a vacuum condition.

Thereafter, sensing characteristics of the pressure sensor 1 are checked by measuring a pressure signal outputted from the sensor output terminal 61 of the assembly 60, and the production of the pressure sensor 1 is completed. Thereafter, an opened end portion of the pressure sensor 1 is fixedly attached to the pipe K1 by a screw connection, welding or a caulked joint.

Therefore, when a measured medium flowing through the pipe K1 is introduced into the hollow 12 of the stem 10, the diaphragm 11 is deformed according to a pressure of the medium. The sensor chip 20 converts this deformation into an electric sensing signal, and the processing circuit of the board 30 coverts this signal into a pressure signal indicating the pressure. The pin assembly 60 outputs the pressure signal to an external device to control a brake system or a fuel injection system of a vehicle.

As described above, in the pressure sensor 1 according to this embodiment, the hollow 12 is formed in the stem 10 such that a center axis of the hollow 12 is shifted from a center axis of the stem 10 toward the remarked side wall 10 by a predetermined value so as to differentiate a thickness of the remarked side wall 10b from those of the other side walls 12b, and the sensor chip 20 is disposed on the diaphragm 11 constituted by a portion of the remarked side wall 10b of the stem 10. A measurable pressure range of the pressure sensor 1 is determined by a material, a shape and a thickness of the diaphragm 11. In the mass production, the material of the diaphragm 11 is predetermined, and the shape of the diaphragm 11 is predetermined by shapes of the stem 10 and the hollow 12. As a result, a measurable pressure range of the pressure sensor 1 is determined only by a thickness of the diaphragm 11. When a desired pressure range of the pressure sensor 1 is determined, a shift of the center axis of the hollow 12 from the center axis of the stem 10 is appropriately set such that the diaphragm 11 has a particular thickness corresponding to the desired pressure range, and the hollow 12 having the shift is formed in the stem 10. Therefore, size and material of the stem 10 not yet having the hollow 12 can be standardized. Further, because the size of the stem 10 is standardized, each of the chip 20, the board 30, the element 40 and the assembly 60 attached to the stem 10 can also be standardized. Accordingly, regardless of whether a desired pressure range is changed in a design study, the pressure sensor 10 can be manufactured at a low cost so as to reliably detect a pressure of a medium within a desired pressure range.

Further, the precision in the thickness of the diaphragm 11 is determined only by a precision in the shift of the hollow 12. Accordingly, the pressure sensor 10 can reliably detect a pressure of a medium with an appropriate precision.

In this embodiment, the center axis of the hollow 12 is shifted from the center axis of the stem 10 toward the remarked side wall 10 to differentiate a thickness of the remarked side wall 10b from those of the other side walls 12b. However, the center axis of the hollow 12 may be shifted from the center axis of the stem 10 in an arbitrary direction to differentiate a thickness of each side wall 10b of the stem 10 from thicknesses of the other side walls 10b. For example, even when a desired pressure range of a pressure sensor to be selected from four pressure ranges is not yet determined, the hollow 12 is formed in the stem 10 so as to form four side walls 10b set at different thicknesses corresponding to the pressure ranges. When a desired pressure range of a pressure sensor is selected from four pressure ranges, the sensor chip 20 is disposed on one side wall 10b having a thickness corresponding to the desired pressure range, and the pressure sensor 10 having the desired pressure range is manufactured.

Accordingly, a designed pressure range of the pressure sensor 10 can be selected from a plurality of pressure ranges after the formation of the stem 10 having the hollow 12. Therefore, the stem 10 can be further standardized.

Further, in this embodiment, the pressure sensor 1 may have four sensor chips 20, respectively, attached to four side walls 10b set at different thicknesses. In this modification, the pressure sensor 1 can have four pressure ranges corresponding to the thicknesses of the side walls 10b.

### Second Embodiment

In the first embodiment, the stem 10 is formed in a square-box shape. However, the stem 10 may be formed in a polygonal-box shape or a polygonal cylindrical shape with a bottom wall.

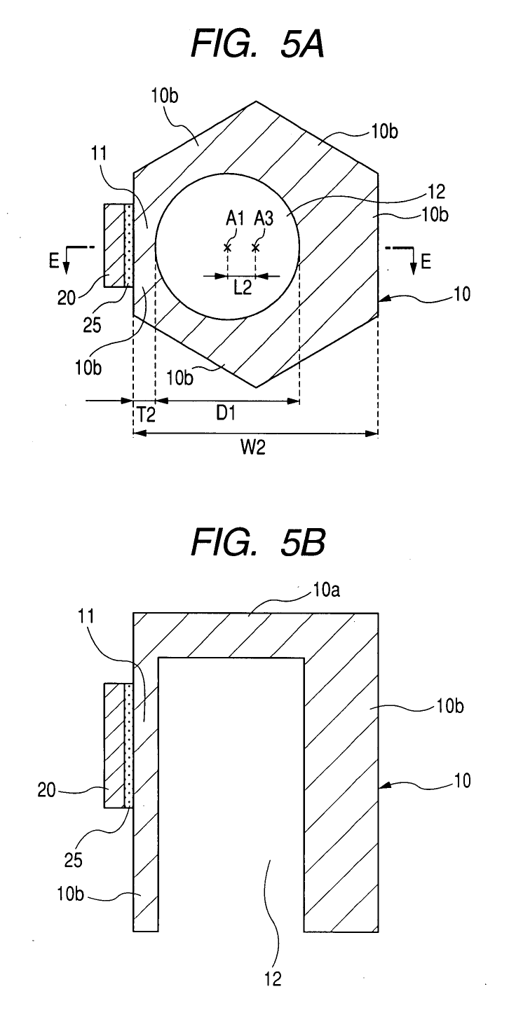

FIG. 5A is a sectional view of a hexagonal cylindrical stem, cut on a plane perpendicular to the longitudinal direction of the stem, according to the second embodiment, while FIG. 5B is a longitudinal sectional view of the stem taken substantially along line E-E of FIG. 5A.

As shown in FIG. 5A and FIG. 5B, a stem 10 is formed in a hexagonal cylindrical shape with a bottom wall 10a and six side walls (or side portions) 10b. The stem 10 has a width W2 between outer surfaces of the side walls 10b opposite to each other. The center axis A1 of the hollow 12 is shifted by a length L2 from a center axis A3 of the stem 10 toward the remarked side wall 10b to differentiate a thickness of the remarked side wall 10b from thicknesses of the other side walls 12b. A minimum thickness T3 of the diaphragm 11 constituted by a portion of the remarked side wall 10b is set at a value of (W2−D1)/2−L2.

Accordingly, in the same manner as in the first embodiment, the pressure sensor 1 with the hexagonal cylindrical stem 10 can have a desired pressure range by appropriately shifting the center axis of the hollow 12 from the center axis of the stem 10 so as to differentiate a thickness of the remarked side wall 10b from thicknesses of the other side walls 12b.

In this embodiment, the center axis of the hollow 12 is shifted toward the remarked side wall 10b. However, the center axis of the hollow 12 may be shifted from the center axis A3 of the stem 10 in an arbitrary direction. In this case, the thickness of each side wall 12b is differentiated from those of the other side walls 12b, so that the diaphragm 11 can be constituted by a portion of any of the six side walls 10b. Therefore, in the same manner as in the first embodiment, six pressure sensors having six different pressure ranges can be, respectively, produced from six stems 10 having the same size and shape and being made of the same material, or a desired pressure range of a pressure sensor can be selected from six candidates for the pressure range after the formation of a stem. Accordingly, the stem can be further standardized.

### Third Embodiment

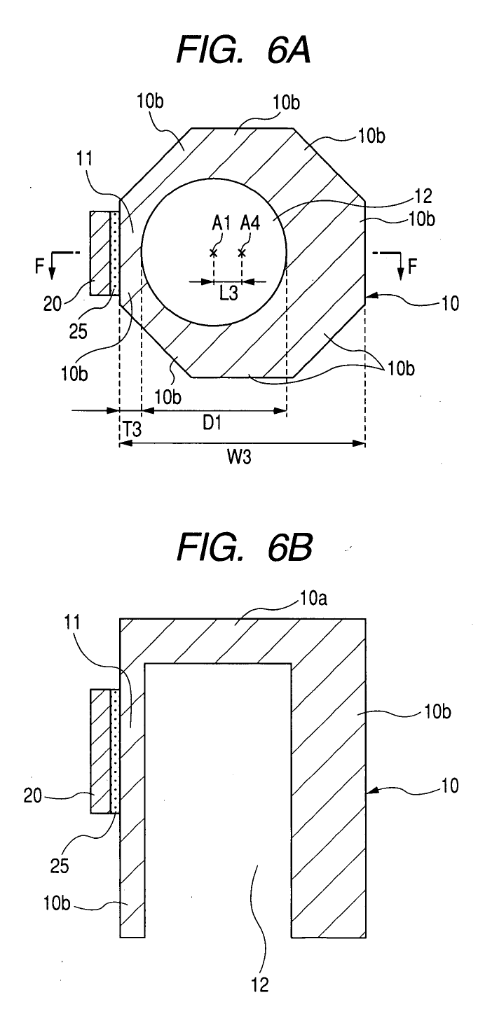

FIG. 6A is a sectional view of an octagonal cylindrical stem, cut on a plane perpendicular to the longitudinal direction of the stem, according to the third embodiment, while FIG. 6B is a longitudinal sectional view of the stem taken substantially along line F-F of FIG. 6A.

As shown in FIG. 6A and FIG. 6B, a stem 10 is formed in an octagonal-cylindrical shape with a bottom wall 10a and eight side walls (or side portions) 10b. The stem 10 has a width W3 between outer surfaces of the side walls 10b opposite to each other. The center axis A1 of the hollow 12 is shifted by a length L3 from a center axis A4 of the stem 10 toward the remarked side wall 10b to differentiate a thickness of the remarked side wall 10b from thicknesses of the other side walls 12b. A minimum thickness T3 of the diaphragm 11 constituted by a portion of the remarked side wall 10b is set at a value of (W3−D1)/2−L3.

Accordingly, in the same manner as in the first embodiment, the pressure sensor 1 with the octagonal cylindrical stem 10 can have a desired pressure range by appropriately shifting the center axis of the hollow 12 from the center axis of the stem 10 so as to differentiate a thickness of the remarked side wall 10b from thicknesses of the other side walls 12b.

In this embodiment, the center axis of the hollow 12 may be shifted from the center axis A4 of the stem 10 in an arbitrary direction. In this case, the thickness of each side wall 12b is differentiated from those of the other side walls 12b, so that the diaphragm 11 can be constituted by a portion of any of the eight side walls 10b. Therefore, in the same manner as in the first embodiment, eight pressure sensors having eight different pressure ranges can be, respectively, produced from eight stems 10 having the same size and shape and being made of the same material, or a desired pressure range of a pressure sensor can be selected from eight candidates for the pressure range after the formation of a stem. Accordingly, the stem can be further standardized.

### First Modification

In the first to third embodiments, the stem 10 is formed in a polygonal cylindrical shape with a bottom wall to obtain flat outer surfaces of the side walls in the stem 10. However, even when a side wall of the stem 10 is curved, the sensor chip 20 can be fixedly attached to the curved side wall. Therefore, a stem formed in a circular cylindrical shape can be used for a pressure sensor.

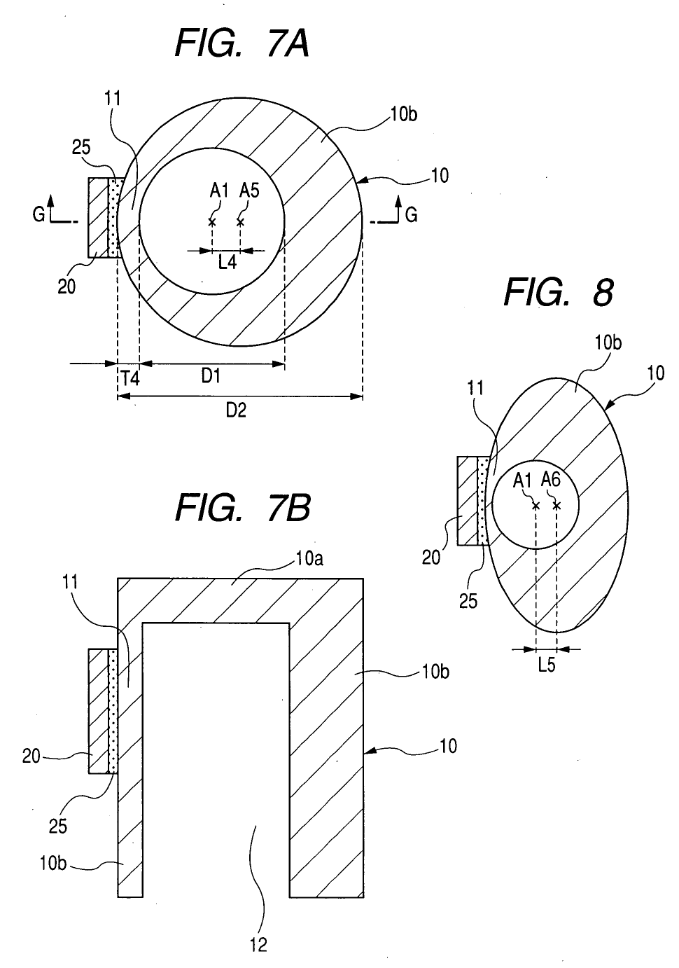

FIG. 7A is a sectional view of a circular cylindrical stem with a circular columnar hollow, cut on a plane perpendicular to the longitudinal direction of the stem, according to the first modification of the third embodiment, while FIG. 7B is a longitudinal sectional view of the stem taken substantially along line G-G of FIG. 7A.

As shown in FIG. 7A and FIG. 7B, a stem 10 is formed in a circular cylindrical shape with a bottom wall 10a and a side wall 10b curved on a plane perpendicular to the longitudinal direction of the stem 10. The stem 10 has an outer diameter D2. The center axis A1 of the hollow 12 is shifted by a length L4 from a center axis A5 of the stem 10 toward a remarked side portion of the side wall 10b. The diaphragm 11 is constituted by the remarked side portion of the side wall 10b. A minimum thickness T4 of the diaphragm 11 is set at a value of (D2−D1)/2−L4.

The sensor chip 20 is attached to the diaphragm 11. To reliably attach the sensor chip 20 having a predetermined size to the diaphragm 11, the outer diameter D2 of the stem 10 is set such that the side wall 10b has a small curvature sufficient to stably attach the sensor chip 20 to the diaphragm 11.

Accordingly, the stem 10 formed in a circular cylindrical shape can be applied to a pressure sensor.

### Second Modification

FIG. 8 is a sectional view of an elliptic cylindrical stem with a circular columnar hollow, cut on a plane perpendicular to the longitudinal direction of the stem, according to the second modification of the third embodiment.

As shown in FIG. 8, a stem 10 is formed in an elliptic cylindrical shape with a bottom wall and a side wall curved on a plane perpendicular to the longitudinal direction of the stem 10. The center axis A1 of the hollow 12 is shifted by a length L5 from a center axis A6 of the stem 10 toward a remarked side portion of the side wall. The diaphragm 11 is constituted by the remarked side portion of the side wall.

Accordingly, in the same manner as the first modification, the stem 10 formed in an elliptic cylindrical shape can be applied to a pressure sensor.

### Embodiment 4

In the first to third embodiments, because the hollow 12 is formed by drilling, the hollow 12 is formed in a circular columnar shape. However, a shape of the hollow 12 on a plane perpendicular to the longitudinal direction of the stem 10 may be similar to a shape of the stem 10 on the plane.

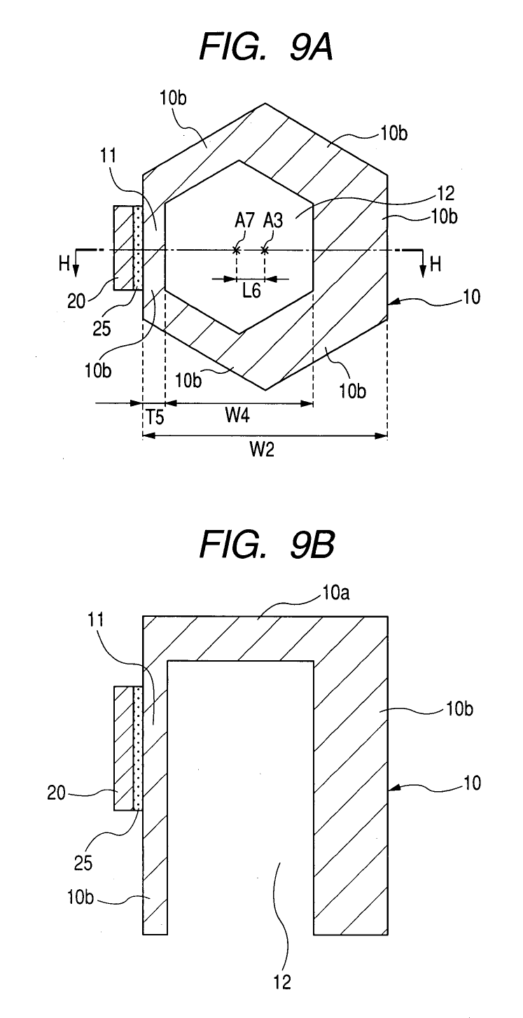

FIG. 9A is a sectional view of a hexagonal cylindrical stem with a hexagonal columnar hollow, cut on a plane perpendicular to the longitudinal direction of the stem, according to the fourth embodiment, while FIG. 9B is a longitudinal sectional view of the stem taken substantially along line H-H of FIG. 9A.

As shown in FIG. 9A and FIG. 9B,the stem 10 is formed in a hexagonal cylindrical shape, and a hollow 12 of the stem 10 is formed in a hexagonal columnar shape. Therefore, a shape of the hollow 12 on a plane perpendicular to the longitudinal direction is set to be similar to a shape of the stem 10 on the plane. A direction of the hollow 12 with respect to the stem 10 is set such that each side wall 10b has an outer surface and an inner surface parallel to each other. The stem 10 has the width W2. The hollow 12 has a width W4 between inner surfaces of the side walls 12b opposite to each other. A center axis A7 of the hollow 12 is shifted by a length L6 from the center axis A3 of the stem 10 toward the remarked side wall 10b. A thickness T5 of the diaphragm 11 is set at a value of (W2−W4)/2−L6.

Accordingly, in the same manner as in the first embodiment, the pressure sensor 1 with the hexagonal cylindrical stem 10 and the hexagonal columnar hollow 12 can have a desired pressure range by appropriately shifting the center axis of the hollow 12 from the center axis of the stem 10 so as to differentiate a thickness of the remarked side wall 10b from thicknesses of the other side walls 12b.

In this embodiment, the center axis A7 of the hollow 12 may be shifted from the center axis A3 of the stem 10 in an arbitrary direction. Accordingly, in the same manner as in the second embodiment, six pressure sensors having six different pressure ranges can be, respectively, produced from six stems 10 having the same size and shape and being made of the same material. Further, a desired pressure range of a pressure sensor can be selected from six candidates for the pressure range after the formation of a stem. Therefore, the stem can be further standardized.

In the first to fourth embodiments, each of the stem 10 and the hollow 12 is shaped so as to have a center axis. However, each of the stem 10 and the hollow 12 may have an arbitrary shape such that a thickness of a remarked side wall is differentiated from those of the other side walls.

Further, the remarked side wall 10b has the thickness smaller than those of the other side walls to heighten a sensitivity of the pressure sensor 1 to pressure. However, the remarked side wall 10b may have a thickness larger than that of one of the other side walls 10b.

### Embodiment 5

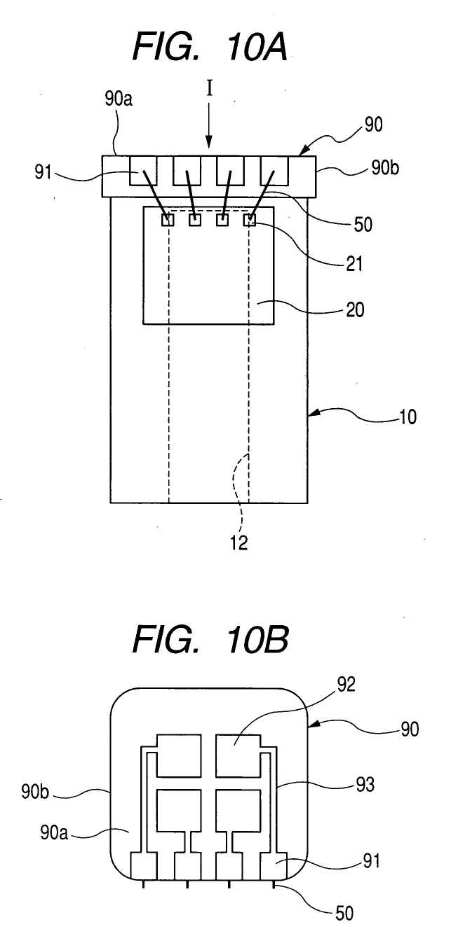

FIG. 10A is a front view of the stem 10 with a processing circuit unit according to the fifth embodiment, while FIG. 10B is a plan view of the stem 10 seen along a direction indicated by an arrow I of FIG. 10A.

As shown in FIG. 10A and FIG. 10B, a processing circuit unit 90 is attached to an outer surface of the bottom wall 10a of the stem 10 by using an adhesive agent. The unit 90 has a function of the processing circuit of the board 90, a function of the wiring element 40 and a function of the pin assembly 60. In other words, the processing circuit of the board 30, the wiring element 40 and the pin assembly 60 are assembled as a single part into the unit 90. The unit 90 is formed as a molded interconnect device. The board 30 is put in the unit 90 as an inserted part. The unit 90 is formed in a square columnar shape having four rounded side corners. The unit 90 has a front surface 90a having a size almost the same as or slightly larger than a size of an outer surface of the bottom wall 10a. The unit 90 has a plurality of pads 91 and a plurality of pads 92. Each pad 91 is disposed on the front surface 90a and a side surface 90b of the unit 90. Each pad 92 is disposed on the front surface 90a. Each pad 92 is electrically connected with the corresponding pad 91 through a wiring 93. Each pad 91 is electrically connected with the corresponding pad 21 of the sensor chip 20 through the bonding wire 50. An electric sensing signal of the sensor chip 20 is transmitted to the unit 90 though the pads 91 and 92 and the wirings 93, and a pressure signal corresponding to the sensing signal is outputted from the unit 90 to an external device.

Accordingly, even when the pressure sensor 1 has the processing circuit unit 90 which has the board 30, the wiring element 40 and the pin assembly 60 as a single part, the pressure sensor 1 can has the same effects as those in the first embodiment.

### Embodiment 6

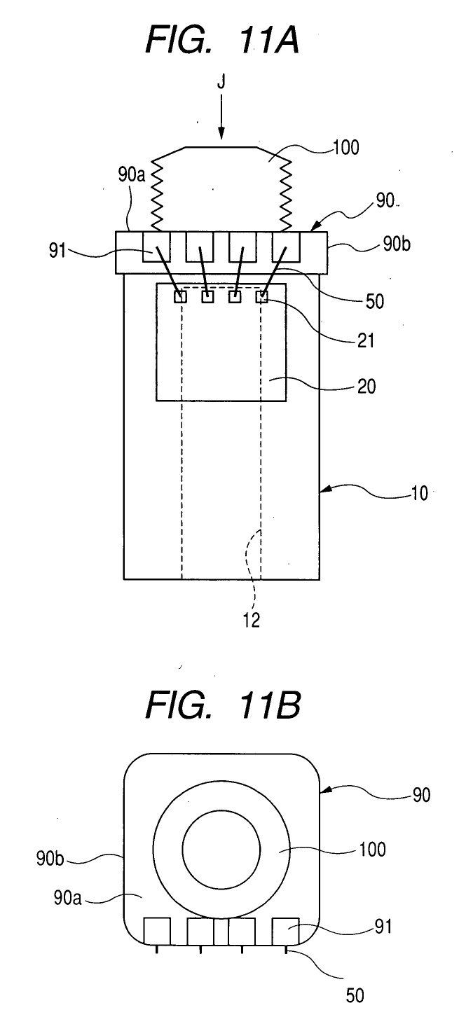

FIG. 11A is a front view of the stem 10 with a screw according to the sixth embodiment, while FIG. 11B is a plan view of the stem 10 seen along a direction indicated by an arrow J of FIG. 11A.

As shown in FIG. 11A and FIG. 11B, the stem 10 has a screw 100 fixedly attached to the processing circuit unit 90 such that the screw 100 can be connected with an external device. The screw 100 may be integrally formed with the unit 90, or the screw 100 maybe attached to the front surface 90a of the unit 90 by an adhesive agent. Further, the screw 100 may be integrally formed with the stem 10 such that the unit 90 penetrates through the screw 100 so as to be attached to the bottom wall 10a of the stem 10.

Accordingly, the pressure sensor 1 can be fixed to an external device through the screw 100.

These embodiments should not be construed as limiting the present invention to structures of those embodiments. For example, the board 30 is disposed on the bottom wall 10a of the stem 10. However, the board 30 may be disposed on an outer surface of one side wall 10b different from the remarked side wall 10b.

Moreover, in these embodiments, the sensor chip 20 is disposed as a sensing element outputting an electric sensing signal indicating a deformation of the diaphragm 11. However, the present invention does not limited to the sensor chip 20. For example, a strain gauge directly deposited and formed on the diaphragm 11 may be used as a sensing element.

What is claimed is:

1. A pressure sensor, comprising:
a cylindrical stem having a remarked side wall and a hollow, the remarked side wall extending along a longitudinal direction of the stem so as to face the hollow of the stem, a center axis of the hollow along the longitudinal direction being differentiated from a center axis of the stem along the longitudinal direction;
a diaphragm constituted by a portion of the remarked side wall or the whole remarked side wall so as to be deformable in response to a pressure of a medium introduced in the hollow of the stem; and
a sensing element, disposed on the remarked side wall, for sensing a deformation of the diaphragm and outputting a sensing signal indicating the deformation of the diaphragm.

2. The pressure sensor according to claim 1, wherein the stem is configured in a polygonal cylindrical shape and has a plurality of side walls including the remarked side wall such that each of the side walls faces the hollow.

3. The pressure sensor according to claim 2, wherein the center axis of the hollow is shifted from the center axis of the stem toward the remarked side wall so as to minimize a thickness of the remarked side wall along a direction perpendicular to the longitudinal direction among those of the side walls.

4. The pressure sensor according to claim 2, wherein the hollow of the stem is configured in a polygonal columnar shape such that a shape of the hollow on a plane perpendicular to the longitudinal direction is similar to a shape of the stem.

5. The pressure sensor according to claim 1, wherein the stem is configured in a circular cylindrical shape, and the diaphragm is constituted by the portion of the remarked side wall.

6. The pressure sensor according to claim 1, wherein the stem is configured in an elliptic cylindrical shape, and the diaphragm is constituted by the portion of the remarked side wall.

7. The pressure sensor according to claim 1, wherein the hollow of the stem is configured in a circular columnar shape.

8. The pressure sensor according to claim 1, wherein a shape of the hollow on a plane perpendicular to the longitudinal direction is similar to a shape of the stem on the plane such that the remarked side wall of the stem has an outer surface and an inner surface parallel to each other, the sensing element is disposed on the outer surface of the remarked side wall, and the inner surface of the remarked side wall faces the hollow.

9. The pressure sensor according to claim 1, further comprising a board with a processing circuit for converting the sensing signal of the sensor element into a pressure signal indicating the pressure of the medium,
wherein the stem has a bottom wall on a first end side of the stem such that the medium is introduced in the hollow from a second end side of the stem opposite to the first end side, and the board is disposed on the bottom wall of the stem.

10. The pressure sensor according to claim 9, further comprising:
a wiring element electrically connecting the sensing element and the processing circuit of the board, and
a pin assembly electrically connected with the processing circuit through the wiring element to output the pressure signal of the processing circuit,
wherein the stem has a plurality of side walls including the remarked side wall, the wiring element is disposed on the remarked side wall, and the pin assembly is disposed on one side wall other than the remarked side wall.

11. The pressure sensor according to claim 1, further comprising:
a processing circuit unit for processing the sensing signal, producing a pressure signal indicating the pressure of the medium and outputting the pressure signal,
wherein the stem has a bottom wall on a first end side of the stem such that the medium is introduced in the hollow from a second end side of the stem opposite to the first end side, and the processing circuit unit is disposed on the bottom wall of the stem.

12. The pressure sensor according to claim 1, further comprising:
a board with a processing circuit for converting the sensing signal of the sensor element into a pressure signal indicating the pressure of the medium,
wherein the stem has a plurality of side walls including the remarked side wall, and the board is disposed on one side wall other than the remarked side wall.

13. The pressure sensor according to claim 1, wherein the sensing element is a sensing chip fixedly attached to the remarked side wall of the stem.

14. The pressure sensor according to claim 1, wherein the sensing element is a strain gauge directly formed on the diaphragm.

15. A pressure sensor, comprising:
a cylindrical stem having a plurality of side portions including a remarked side portion, each of the side portions extending along a longitudinal direction of the stem so as to face a hollow of the stem, a thickness of the remarked side portion along a direction perpendicular to the longitudinal direction being differentiated from a thickness of each of the other side portions;
a diaphragm constituted by the remarked side portion so as to be deformable in response to a pressure of a medium introduced in the hollow of the stem; and
a sensing element, disposed on the remarked side portion, for sensing a deformation of the diaphragm and outputting a sensing signal indicating the deformation of the diaphragm.

16. The pressure sensor according to claim 15, wherein the thickness of the remarked side portion is set to be smaller than the thickness of each of the other side portions.

17. The pressure sensor according to claim 15, further comprising:
another sensing element or a plurality of other sensing elements, respectively, disposed on the side portions other than the remarked side portion, each of the sensing elements sensing a deformation of a diaphragm constituted by the corresponding side portion and outputting a sensing signal indicating the deformation of the diaphragm,
wherein the thickness of each of the side portions is differentiated from the thicknesses of the other side portions.

18. The pressure sensor according to claim 15, wherein the side portions of the stem have thicknesses different from one another.

19. The pressure sensor according to claim 15, wherein the stem is configured in a polygonal cylindrical shape so as to have the side portions including the remarked side portion.

20. The pressure sensor according to claim 19, wherein the hollow of the stem is configured in a polygonal columnar shape such that a shape of the hollow on a plane perpendicular to the longitudinal direction is similar to a shape of the stem.

21. The pressure sensor according to claim 15, wherein the hollow of the stem is configured in a circular columnar shape.
